(19) United States
(12) Patent Application Publication
(10) Pub. No.: US 2014/0367269 A1
(43) Pub. Date: Dec. 18, 2014

(54) METHODS AND SYSTEMS FOR HYDROGEN DISSOCIATION

(71) Applicant: Charles G. Inskeep, Descanso, CA (US)

(72) Inventor: Charles G. Inskeep, Descanso, CA (US)

(21) Appl. No.: 14/473,463

(22) Filed: Aug. 29, 2014

Related U.S. Application Data
(63) Continuation of application No. 12/970,425, filed on Dec. 16, 2010, now abandoned.

(51) Int. Cl. C25B 15/02; C25B 1/04

(52) U.S. Cl. CPC C25B 15/02; C25B 1/04
USPC 205/335; 204/230.6

(57) ABSTRACT

A system for dissociating hydrogen from water is disclosed. The system comprises a container having an anode electrode and a cathode electrode disposed therein; a DC voltage source producing a DC voltage; a controller having an input coupled to the DC voltage source, and an output coupled across the anode and cathode electrodes; and an electron extraction circuit arranged to capture the free electrons released from the water molecules. The controller is configured to produce from the DC voltage a pulse voltage having a stepped up voltage and a pulse frequency. The amplitude and frequency of the pulse voltage are sufficient to dissociate hydrogen and oxygen from water molecules of the water in the container and produce free electrons, and the pulse frequency is configured to maximize a rate of hydrogen and oxygen dissociated from the water molecules.

### CROSS-REFERENCE TO RELATED APPLICATIONS

This application is a continuation of U.S. patent application Ser. No. 12/970,425, filed Dec. 16, 2010, the disclosure of which is incorporated herein by reference in its entirety.

### TECHNICAL FIELD

The present invention relates generally to fuel production, and, particularly, to methods and systems for dissociating hydrogen from water.

### BACKGROUND

Methods for separating hydrogen from water include electrolysis, which employs an electrical potential across a pair of electrodes immersed in an electrolyte. For example, the electrodes may absorb or release electrons from or onto the water molecule to oxidize and reduce the water to yield an overall reaction of 2H₂O (liquid)→2H₂ (gas)+O₂ (gas). Electrolysis of water produces significant waste heat thereby limiting efficiency. Accordingly, there remains a need for an energy efficient process to dissociate hydrogen from water.

### SUMMARY

According to an embodiment of the present invention, a system for dissociating hydrogen from water is disclosed comprising a container having an anode electrode and a cathode electrode disposed therein, wherein the container is configured to contain a volume of water; a DC voltage source producing a DC voltage; a controller having an input coupled to the DC voltage source, and an output coupled across the anode and cathode electrodes, the controller being configured to produce from the DC voltage a pulse voltage having a stepped up voltage and a pulse frequency, wherein the amplitude and frequency of the pulse voltage are sufficient to dissociate hydrogen and oxygen from water molecules of the water in the container and produce free electrons, wherein the pulse frequency is configured to maximize a rate of hydrogen and oxygen dissociated from the water molecules; and an electron extraction circuit arranged to capture the free electrons released from the water molecules.

According to another embodiment, a method for dissociating hydrogen from water is disclosed comprising providing water in a container; applying a pulsed voltage at a frequency across the anode and cathode electrodes arranged in the water in the container in order to dissociate hydrogen and oxygen from water molecules of the water in the container; monitoring a pressure change in the container caused by a rate of hydrogen and oxygen dissociated from water molecules of the water in the container; and configuring the frequency of the pulsed voltage to maximize the pressure change.

Further aspects, objectives, and advantages, as well as the structure and function of embodiments, will become apparent from a consideration of the description, drawings, and examples.

### BRIEF DESCRIPTION OF THE DRAWINGS

The features and advantages of the invention will be apparent from the following drawings wherein like reference numbers generally indicate identical, functionally similar, and/or structurally similar elements.

FIG. 1 is a process flow diagram of an embodiment of a system for separating hydrogen from water;

FIG. 2 is an anode electrode and a cathode electrode according to an embodiment;

FIG. 3 is a simplified diagram of water molecules between an anode electrode and a cathode electrode according to an embodiment; and

FIG. 4 is a simplified diagram of a hydrogen molecule between an anode electrode and a cathode electrode according to an embodiment.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without departing from the spirit and scope of the invention.

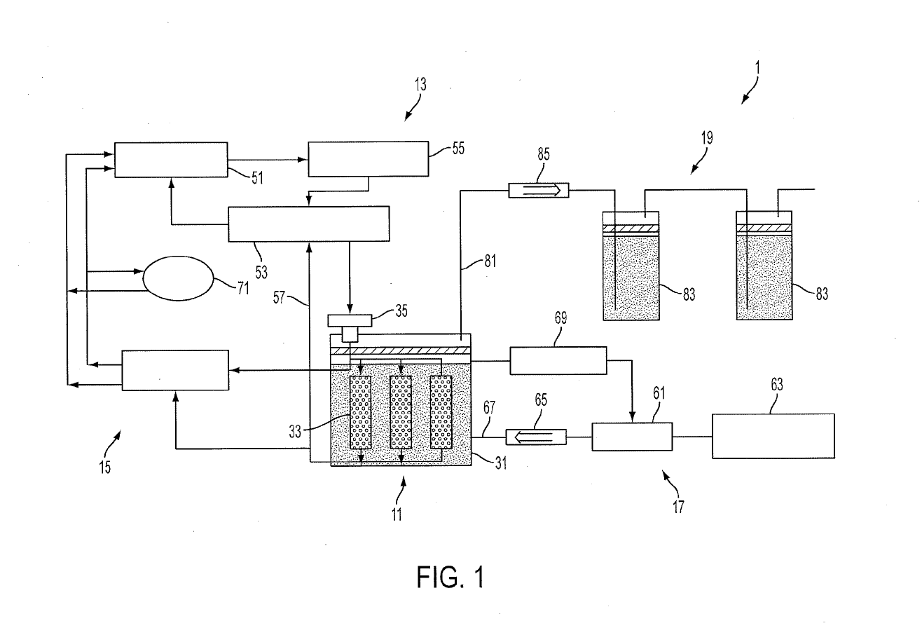

Referring now to FIG. 1, a system 1 for dissociating hydrogen from water molecules is illustrated. The system 1 may generally comprise a splitting section 11, a power control section 13, an electron extraction circuit 15, a water supply section 17, and a fuel extraction section 19. As explained in more detail below, system 1 may split the water molecule into constituent parts according to the following equation:

H₂O→2H⁺+O+2e⁻

The system 1 may split the water molecule into constituent parts by subjecting the water molecule to physical stress applied by an amplitude of voltage at a resonant frequency that also subjects the water molecule to an electric field. As explained in more detail below, the combination of physical stress and electric field may result in molecular fission to split the water molecule into the constituent parts.

The splitting section 11 may comprise a container 31 having at least one or a plurality of electrode pairs 33 therein. For example, the container 31 may be a sealed container having a pressure relief valve 35 thereon. The container may be configured to hold water therein such that the electrode pair 33 is at least partially or completely submersed in the water. According to an embodiment, the container 31 may be formed or molded from a plastic or other nonconductive material, as known by one of ordinary skill in the art.

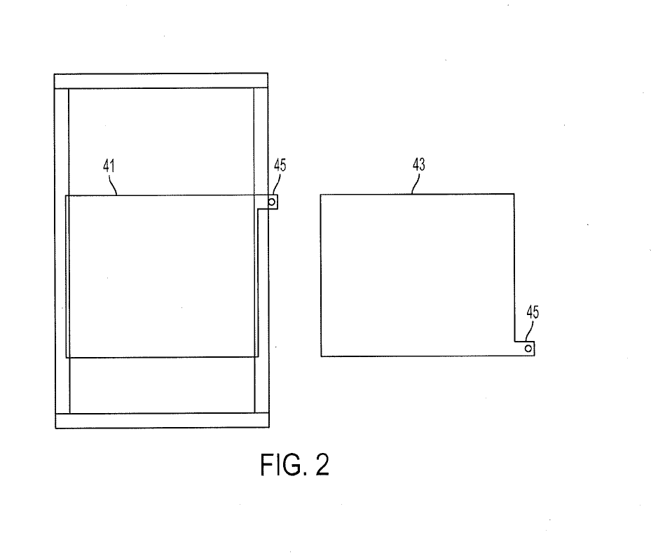

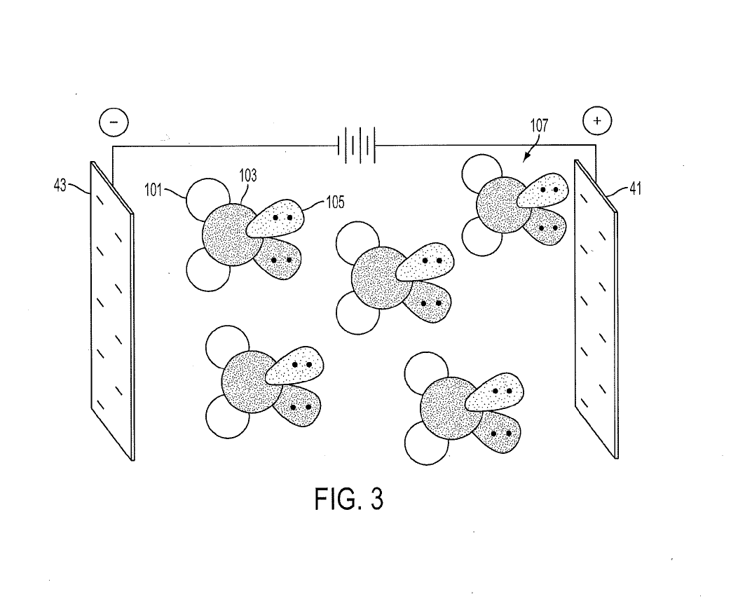

Referring now to FIGS. 2 and 3, the electrode pair 33 may comprise an anode electrode 41 and a cathode electrode 43. The anode electrode 41 and the cathode electrode 43 may be spaced at a predetermined distance from each other to form a dipole. With the plurality of electrode pairs 33, the spacing between the respective anode electrode 41 and cathode electrode 43 of each electrode pair 33 may be the same or approximately the same.

Referring now to FIG. 2, the anode electrode 41 and the cathode electrode 43 may each be formed having a tab 45 extending therefrom. When assembled with the container 31, the respective tabs 45 of the anode electrode 41 and the cathode electrode 43 may be received by grooves or slots formed in the inner sides of the container 31. For example, the tabs may help maintain the predetermined distance between the anode electrode 41 and the cathode electrode 43 by the slots or grooves pre-formed in the container 31.

According to an embodiment, the tabs 45 may indicate the direction from which the respective electrodes 41 and 43 are electrically connected. For example, the tab 45 of the anode electrode 41 may be located towards the bottom of the container 31 to indicate that the anode electrode 41 is electrically connected at or towards the bottom end, and the tab 45 of the cathode electrode 43 may be located towards the top of the container 31 to indicate that the cathode electrode 43 is electrically connected at or towards the top end. By electrically connecting the anode electrode 41 and the cathode electrode 43 at or towards opposite ends, magnetic fields created by each of the anode electrode 41 and the cathode electrode 43 may aid each other to establish current flow through water contained in the container 31.

It is foreseen that the anode electrode 41 and the cathode electrode 43 may be formed of 0.065″ metal tubing, flat sheets of metal, or thin shim stock. According to an embodiment, the anode electrode 41 and the cathode electrode 43 may be formed by plates stamped from 0.0625″ stainless steel type 316L or aluminum.

As explained in further detail below, the water contained in the container 31 may be subjected to voltage through the electrode pairs 33 in order to dissociate hydrogen from the water molecule. The power control section 13 and the splitting section 11 comprises a circuit to step up the amplitude of the voltage and tune the pulse frequency to a resonant frequency of the container with the water and electrodes disposed therein sufficient to dissociate hydrogen from the water contained in the container 31.

According to an embodiment, the power control section 13 may be configured to apply a high voltage pulsed at a predetermined frequency to the electrode pairs 33 contained in the container 31 of the splitting section 11. In order to apply the voltage pulses, the power control section 13 may comprise a power source 51 and a controller 53. According to an embodiment, the power control section 13 may further comprise a power switch circuit breaker 55. As illustrated at FIG. 1, the controller 53 may be connected between the power source 51 and the electrode pairs 33. The controller 53 may be configured to control the predetermined frequency of voltage pulses from the power source 51 to the electrode pairs 33.

According to an embodiment, the power source 51 may be a 12 volt battery. The direct current from the power source 51 may be provided to the controller 53. According to an embodiment, the direct current may be provided through the power switch circuit breaker 55 to the controller 53. For example, the controller 53 may be configured to include a boost or step-up converter, as known to one of ordinary skill in the art. For example, the boost or step-up converter may step up the 12 volts provided by the power source 51 to 5,000 volts at low current. For example, the current may be 10 milliamps or less in a high Q factor circuit. It is foreseen that the boost or step-up converter may step up 12 volts to in excess of 5,000 volts, such as, for example, 20,000 volts at 150 milliamps. For example, at such low currents, heat loss is minimized.

The predetermined frequency of voltage pulses from the power source 51 to the electrode pairs 33 may be set according to a resonant frequency or a sub-multiple of the resonant frequency sufficient to dissociate hydrogen from the water contained within the container 31. The resonant frequency sufficient to dissociate hydrogen from the water contained within the container 31 may be a resultant resonant frequency of the resonant frequency of the circuit comprising the power control section 13 and the splitting section 11 and the resonant frequency of the water in the container 31. The resonant frequency of the water in the container 31 may be the resonant frequency of a vibrating O—H bond.

However, the resonant frequency of the water in the container 31 may depend upon, for example, but not limited to, temperature, water volume, and impurities in the water. Further, the resonant frequency of the water may be dynamic depending on variances of the conditions. Accordingly, the controller 53 may be configured to vary the predetermined frequency between 0 kHz and 45 kHz as conditions vary to change the resonant frequency of the water. As explained below, the predetermined frequency may be set at the resonant frequency, multiple, or sub-multiple of the resonant frequency sufficient to perform ionization and hydrogen fracturing of the water to produce monatomic hydrogen.

The controller 53 may be further configured to vary the voltage amplitude and the duty cycle of the predetermined frequency. For example, the controller 53 may be configured to vary the voltage from 0V to in excess of 5,000V, for example up to 20,000V, and vary the duty cycle between 5% and 90%. The varying voltages and duty cycles may be used to optimize the circuit for optimal hydrogen dissociation and ionization.

According to an embodiment, an external variable inductor may be further included with or in the controller 53 of the power control section 13. For example, the external variable inductor may be a parallel circuit to the splitting section 11. The external variable inductor may be configured to tune the total configuration of the circuit to the resonant or sub-resonant frequency of the water contained in the container 31. According to an embodiment, the external variable inductor may tune the system to achieve a high Q factor. For example, the system having a high Q factor may resonate with greater amplitude at the resonant frequency but have a smaller range of frequencies around the resonant frequency.

The method of producing monatomic hydrogen from H₂O utilizes a process generally called molecular fission or, specifically, hydrogen fracturing. According to an embodiment, hydrogen fracturing utilizes high direct voltage and low current to generate high voltage, polarized electrical pulses at the resonant frequency of the circuit sufficient to break the O—H bond of the water molecule. The pulses of the electrical field oscillate the O—H bond of the H₂O molecule at such a frequency, such as a resonant frequency, multiple, or sub-multiple of the resonant frequency, to break the bond.

Referring now to FIG. 3, the H₂O molecules subject to the electric field of the pulsed voltage, generally shown as 107, may align into a periodic formation with the hydrogen atoms 101 aligning toward the cathode 43, and the free electrons 105, which refer to the electrons which are not being used for bonding, on the oxygen 103 positioned facing the anode 41. The alignments of the hydrogen atoms 101 and the positioning of the free electrons 105 may occur because the positive charge on the anode 41 attracts the free electrons 105, while the negative charge of the cathode 43 attracts the partially positive dipole on the hydrogen atoms 101. For example, the dipole refers to the electric dipole moment of the molecule which relates the separation of positive and negative charge on a molecule. Additionally, the dipole moment may be treated as a vector which may align with the electric field. Further reasons for alignment may be achieved due to hydrogen bonding, where the hydrogen atoms 101 in polar molecules, for example H₂O 107, create a strong dipole-dipole attraction with the negative dipole of other polar molecules.

According to an embodiment, pulsing the electric field at a frequency harmonic to the O—H bond vibrations of the H₂O molecule 107 may excite the O—H bond into breaking. The breaking of the O—H bond may occur due to the physical stress placed on the bond by the amplitude of the pulsed voltage.

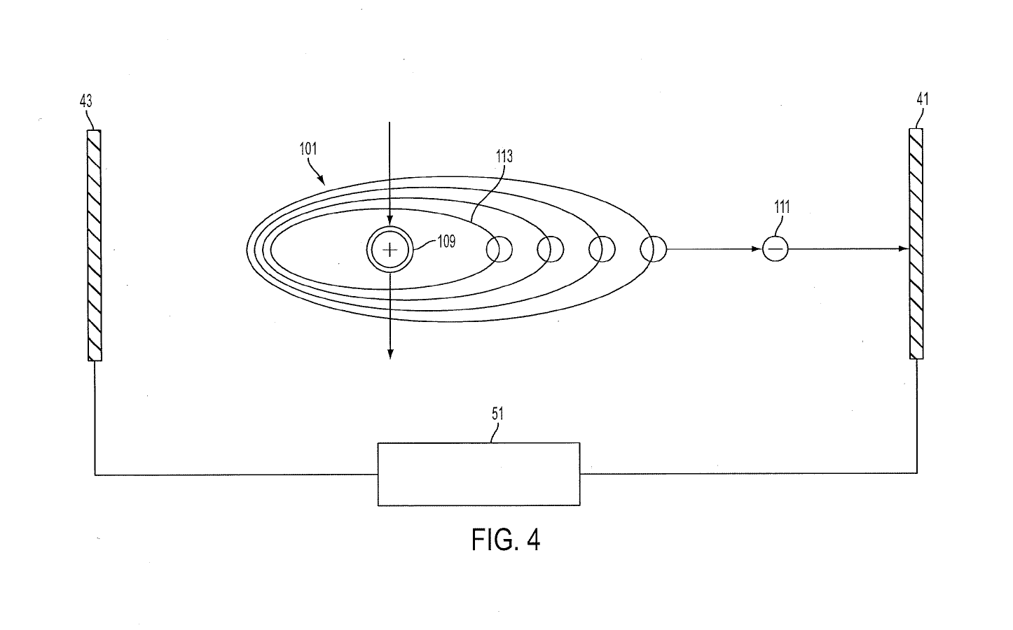

Referring now to FIG. 4, the electrons may be extracted simultaneously to the hydrogen fracturing used to dissociate the H₂O molecule. According to an embodiment, attracting the positive nucleus 109 of one of the atoms using the cathode 43, and attracting the electron 111 using the anode 41, the pulse of the electric field at the resonant or sub-resonant frequency may pull the electron 111 away from the nucleus 109. For example, as the field is pulsed, the strong attractive forces may pull the electron 111 off of the atom, resulting in ionization, which refers to the atom or molecule gaining a positive or negative charge. According to an embodiment, the pulsed electric field pulling the electron 111 away from the nucleus 109 may result in a higher probability of the electrons 111 being found farther away from the nucleus 109. If the electron 111 has a probable location outside the orbital 113, the electron 111 may break free of the orbital 113 and atom so that ionization of the atom occurs.

According to an embodiment, the controller 53 may have a feedback 57 from the pressure relief valve 35 on the container 31. The controller 53 may sense the pressure of the container 31 and/or the rate of change of pressure of the container 31 to determine if the predetermined frequency of voltage pulses from the power source 51 is at or near the resonant frequency, multiple, or sub-multiple of the resonant frequency of the water. For example, a high pressure or a high rate of change of pressure sensed by the controller 53 at the feedback 57 may indicate the frequency of voltage pulses from the power source 51 is at or near the resonant frequency, multiple, or sub-multiple of the resonant frequency of the water. The pressure in the container 31 may increase due to the hydrogen dissociating from the water molecule and as water is replenished from the water supply section 17, explained below. In contrast, a low pressure or low rate of change of pressure sensed by the controller 53 at the feedback 57 may indicate the frequency of voltage pulses from the power source 51 is not at or near the resonant frequency, multiple, or sub-multiple of the resonant frequency of the water and is not dissociating hydrogen from the water molecule.

According to an embodiment, the water supply section 17 may be configured to supply water to the container 31 of the splitting section 11. The water supply section 17 may comprise pump 61 to pump water from a water tank 63 to the container 31. The water tank 63 may be configured to store a volume of water for use in the container 31. For example, the water stored in the water tank may be distilled water, salt water, or other types of water. It is foreseen that additives or contaminants may be added to or removed from water in the water tank 63 in order to achieve a water having a desired resonant frequency.

The pump 61 may be any type of pump such as, for example, but not limited to, a gear pump, a piston pump, a screw pump, a diaphragm pump, or other pumps as known to one of ordinary skill in the art

According to an embodiment, a water inlet 67 to the container 31 from the pump 61 may be located towards the bottom of the container 31. A check valve 65 may be located between the pump and the container 31 to order to prevent gravity driven backflow from the container 31. According to another embodiment, the water inlet 67 may be located towards the top of the container 31. In such an embodiment, no check valve may be necessary because water cannot backflow by gravity from the container 31.

According to an embodiment, the water supply section 17 may further comprise a level sensor 69 operatively connected to the container 31 of the splitting section 11. The level sensor 69 may include a level switch such as a float or other sensor to detect a water level in the container 31. The level sensor may be configured to detect a water level in the container 31 corresponding to a predetermined volume of water to achieve a desired resonant frequency. For example, as the water level in the container 31 decreases, the level 59 may activate the pump 61 to supply additional water to the container 31 from the water tank 63.

According to an embodiment, the electron extraction circuit 15 may be configured to extract free electrons from the container 31. As explained above, the system 1 may dissociate and ionize water H₂O into two monatomic hydrogen ions, one monatomic oxygen ion, and two free electrons e. As a result of ionization of the water, as explained above, the free electrons may be extracted by the electron extraction circuit 15. For example, the electron extraction circuit 15 may comprise a screen conductor between the anode electrode 41 and cathode electrode 43 in the container 31 to extract the free electrons or current. The current generated by the free electrons extracted by the electron extraction circuit 15 depends on the rate of ionization of the water in the container 31.

The electron extraction circuit 15 may be configured to power an external load 71 with the extracted free electrons or current. For example, the external load 71 may be a battery charger, a light, a heating element, or any other electrical load as known to one of ordinary skill in the art. The electron extraction circuit 15 may be further configured to charge the power source 51.

According to an embodiment, the fuel extraction section 19 may be configured to extract the monatomic hydrogen ion, the monatomic oxygen ion, and/or a hydroxy, OH, in gas form. As a result of dissociation and ionization, the monatomic hydrogen ions, the monatomic oxygen ion, and/or the hydroxy OH may build up pressure in the container 31 and exit through the fuel extraction section 19. According to an embodiment, the pressure relieve valve 35 may be set, for example, at 5 psi absolute or less in order to prevent overpressure of the container 31 or other combustion.

The fuel extraction section 19 may comprise a fuel outlet 81 and at least one or a plurality of bubblers 83. As oxygen ions, hydrogen ions, and/or hydroxy gas exits the container 31 through the fuel outlet 81, the oxygen ions, hydrogen ions, and/or hydroxy gas passes through the at least one or more bubblers 83 in order to prevent back flow or back flash of the gases that may occur downstream. According to an embodiment, a check valve 85 may be included with the fuel extraction section 19 in order to prevent back flow of the oxygen ions, hydrogen ions, and/or hydroxy gas.

According to an embodiment, monatomic oxygen ions and monatomic hydrogen ions may be separated into separate chambers or vessels. For example, the oxygen ions and the hydrogen ions may be separated with electric fields and/or magnetic fields.

It is foreseen that the fuel extracted by the fuel extraction section 19, whether hydroxy gas, monatomic oxygen ions, monatomic hydrogen ions, or a combination thereof, may be used as fuel for an internal combustion engine, a generator to charge batteries, or other apparatus as known to one of ordinary skill in the art.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

I claim:

1. A system for dissociating hydrogen from water, the system comprising:
a container having an anode electrode and a cathode electrode disposed therein, wherein the container is configured to contain a volume of water;
a DC voltage source producing a DC voltage;
a controller having an input coupled to the DC voltage source, and an output coupled across the anode and cathode electrodes, the controller being configured to produce from the DC voltage a pulse voltage having a stepped up voltage and a pulse frequency, wherein the amplitude and frequency of the pulse voltage are sufficient to dissociate hydrogen and oxygen from water molecules of the water in the container and produce free electrons, wherein the pulse frequency is configured to maximize a rate of hydrogen and oxygen dissociated from the water molecules; and
an electron extraction circuit arranged to capture the free electrons released from the water molecules.

2. The system of claim 1, wherein the amplitude of the DC voltage applied to the anode electrode and cathode electrode is sufficient to ionize the water.

3. The system of claim 2, wherein the controller is configured to adjust the pulse frequency to correspond to a resonant frequency or submultiple of the resonant frequency of the container with the volume of water.

4. The system of claim 1, wherein the controller further comprises a step up converter to convert the voltage of the power source to a relatively higher voltage than the DC voltage source of at least 5000 volts.

5. The system of claim 1, wherein the controller and the container comprise an electrical circuit, wherein the controller further comprises an external variable inductor configured to tune the electrical circuit to achieve a predetermined Q factor.

6. The system of claim 5, wherein the external variable inductor is in electrical parallel with the anode and cathode electrodes.

7. The system of claim 1, further comprising a fuel extraction section configured to extract at least one of monatomic oxygen, monatomic hydrogen and hydroxy gas from the container.

8. The system of claim 1, further comprising a water supply section configured to supply water to the container.

9. A method for dissociating hydrogen from water, the method comprising:
providing water in a container;
applying a pulsed voltage at a frequency across the anode and cathode electrodes arranged in the water in the container in order to dissociate hydrogen and oxygen from water molecules of the water in the container;
monitoring a pressure change in the container caused by a rate of hydrogen and oxygen dissociated from water molecules of the water in the container; and
configuring the frequency of the pulsed voltage to maximize the pressure change.

10. The method of claim 9, further comprising ionizing the water with the voltage.

11. The method of claim 10, wherein the frequency of the pulsed voltage is sufficient to split the water molecule into a monatomic hydrogen, a monatomic oxygen, and a free electron.

12. The method of claim 11, further comprising extracting the free electron from the container.

13. The method of claim 12, further comprising extracting the monatomic hydrogen and the monatomic oxygen from the container.

14. The method of claim 12, wherein the configuring comprises adjusting the frequency of the pulsed voltage to maximize the pressure change.

15. The method of claim 14, wherein adjusting the frequency of the pulsed voltage adjusts a rate of pressure change in the container caused by a changed rate of hydrogen and oxygen dissociated from water molecules of the water in the container.
